(19) United States
(12) Patent Application Publication
(10) Pub. No.: US 2024/0184640 A1
(43) Pub. Date: Jun. 6, 2024

(54) METHOD AND DESIGN FOR PARALLEL DEPLOYMENT OF TELCO APPLICATION WITH SERVERLESS FRAMEWORK IN HYBRID CLOUDS

(71) Applicant: RAKUTEN MOBILE, INC., Tokyo (JP)

(72) Inventors: Kranthi MOLLETI, Indore (IN); Siddharth JOSHI, Indore (IN)

(73) Assignee: RAKUTEN MOBILE, INC., Tokyo (JP)

(21) Appl. No.: 17/795,292

(22) PCT Filed: Apr. 28, 2022
(86) PCT No.: PCT/US2022/026644

§ 371 Date: Jul. 26, 2022

(51) Int. Cl. G06F 9/52

(52) U.S. Cl. CPC G06F 9/52

(57) ABSTRACT

A method for parallel deployment of telecommunication applications may be provided. The method, executed by a cloud adaptor, may include receiving a network topology, a resource status of each of one or more available clusters, and a cluster context associated with the each of the one or more available clusters. The method may include spawning a plurality of threads wherein each of the plurality of threads may be associated with a respective cluster and a respective task to be executed on the respective cluster, and wherein the respective task may be associated with a respective function to be performed. The method may include setting the cluster context associated with the respective cluster to the respective function to be performed associated with the respective task to be executed on the respective cluster; and directing parallel execution of the plurality of threads across the one or more available clusters.

### BACKGROUND

Deploying telecommunication applications, including network functions and services, require hosting servers and are managed using microservices, which can be a significant consumer of resources in a telecommunication network. With an increase in the services provided by a telecommunication network, additional dedicated servers may be needed for deploying and managing telecommunication applications. For example, an increase in network functions and services may require additional storage and processing capacity. Changes to the infrastructure of the telecommunication network to accommodate these additional requirements may be very expensive as well. Leveraging cloud computing is also difficult in a server-based system using microservices because servers may have to be dedicated to and/or server management may have to be customized to specific cloud types.

Thus, methods and systems that are efficient, scalable, and cloud agnostic may be needed for the deployment of telecommunication applications.

### SUMMARY

According to embodiments, a method for parallel deployment of telecommunication applications, executed by a cloud adaptor including one or more processors may be provided. The method may include receiving a network topology of a telecommunication network; receiving a resource status of each of one or more available clusters and a cluster context associated with the each of the one or more available clusters, wherein the each of the one or more available clusters is identified based on the network topology; spawning a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed; setting the cluster context associated with the respective cluster to the respective function to be performed associated with the respective task to be executed on the respective cluster; and directing parallel execution of the plurality of threads across the one or more available clusters.

According to embodiments of the present disclosure, directing the parallel execution of the plurality of threads may include receiving a plurality of job identifiers, wherein each job identifier of the plurality of job identifiers is a unique identifier for the respective task to be executed on the respective cluster; polling the each job identifier of the plurality of job identifiers to check a status of the each job identifier; and updating the status of the each job identifier based on the polling.

According to embodiments of the present disclosure, the network topology may include a template of a telecommunication network.

According to embodiments of the present disclosure, the network topology may include one or more network functions or one or more network services to be deployed in parallel using the one or more available clusters and one or more available nodes in the each of the one or more available clusters.

According to embodiments of the present disclosure, the resource status of the each of the one or more available clusters and the cluster context of the each of the one or more available clusters may be received from a central inventory.

According to embodiments of the present disclosure, the tasks may include actions associated with at least one of deployment, deletion, restart, upgrade, healing, termination, and updating of one or more network functions or one or more network services to be deployed.

According to embodiments of the present disclosure, the one or more available clusters may include at least one of a public cluster, a private cluster, a hybrid cluster, or a combination thereof.

According to embodiments of the present disclosure, the resource status of the each of the one or more available clusters may be based on a network function or a network service associated with the one or more available clusters, one or more affinity rules associated with the one or more available clusters, or one or more anti-affinity rules associated with the one or more available clusters.

According to embodiments, an apparatus for parallel deployment of telecommunication applications may be provided. The apparatus may include a memory configured to store instructions; and one or more processors implementing a cloud adaptor configured to execute the instructions that receive a network topology of a telecommunication network; receive a resource status of each of one or more available clusters and a cluster context associated with the each of the one or more available clusters, wherein the each of the one or more available clusters is identified based on the network topology; spawn a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed; set the cluster context associated with the respective cluster to the respective function to be performed associated with the respective task to be executed on the respective cluster; and direct parallel execution of the plurality of threads across the one or more available clusters.

According to embodiments, a non-transitory computer-readable medium storing instructions may include one or more instructions that, when executed by one or more processors, may cause the one or more processors to receive a network topology of a telecommunication network; receive a resource status of each of one or more available clusters and a cluster context associated with the each of the one or more available clusters, wherein the each of the one or more available clusters is identified based on the network topology; spawn a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed; set the cluster context associated with the respective cluster to the respective function to be performed associated with the respective task to be executed on the respective cluster; and direct parallel execution of the plurality of threads across the one or more available clusters.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a block diagram for parallel deployment of telecommunication applications in a cloud agnostic serverless framework, according to embodiments;

FIG. 2 is a diagram of an example environment in which systems and/or methods, described herein, may be implemented, according to embodiments;

FIG. 3 is a diagram of example components of one or more devices of FIG. 2, according to embodiments; and

FIG. 4 is a flow chart of an example process for parallel deployment of telecommunication applications in a cloud agnostic serverless framework, according to embodiments;

FIG. 5 is a block diagram illustrating exemplary network topology, according to embodiments;

FIG. 6 illustrates a diagram of an example workflow for parallel deployment of telecommunication applications in a cloud agnostic serverless framework, according to embodiments;

FIG. 7 illustrates a diagram of an example workflow for parallel deployment of telecommunication applications in a cloud agnostic serverless framework, according to embodiments; and

FIGS. 8A-8B illustrate exemplary experimental results of parallel deployment of telecommunication applications in a cloud agnostic serverless framework, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

As is traditional in the field, embodiments may be described and illustrated in terms of blocks which carry out a described function or functions. These blocks, which may be referred to herein as units or modules or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise.

Embodiments of the present disclosure relate to cloud agnostic serverless framework for automation and parallel deployment of telecommunication applications. The cloud agnostic serverless framework and embodiments described herein may include a distributed or centralized cloud adaptor system that may direct and control the deployment of applications, network functions, and/or network services on a plurality of clusters in any type of cloud computing system including public cloud, private cloud, hybrid cloud, or any combination thereof.

In a server-based system that uses microservices to deploy applications, network services, and/or network functions, as the number of applications being deployed increase, the system's computation speed may decrease up to 90% linearly because the processing load on the central server increases. Scaling up of parallel computing in server based systems may increase expenses significantly because additional operational and hardware resources may be required. Further system storage and memory requirements may be very high as well because multiple copies of the data may be stored to maintain the resiliency and redundancy of data across the network. Because of the resource intensive nature of deploying applications in a server-based system that uses microservices, responsiveness of the system may decrease considerably as the number of applications deployed increases.

The use of a cloud agnostic serverless framework will enable parallel deployment of telecommunication applications, improving resource utilization in the telecommunication network. A serverless framework, relying on cloud platforms and leveraging Functions as a Service (FaaS) will improve memory requirements and computing resources when compared to traditional dedicated server methods by leveraging available resources from a cluster of computers or servers dynamically.

The serverless framework and embodiments described herein may include utilizing threads and associated tasks that implement network functions and services without dedicated servers for processing and deploying telecommunication applications. Traditional dedicated servers and server managers may be replaced with clusters of computers and/or processors provisioned dynamically. With respect to the applications deployed, more applications may be deployed more efficiently by leveraging parallel processing of applications. With the advent of 4G and 5G, there is a significant increase in the services a telecommunication network provides and an increase in the number of users a telecommunication network may serve, which may increase the strain on network resources. Improving parallel deployment and/or processing of applications using clusters of computers will not only reduce the strain on the network but also increase network efficiency and quality of service.

Additionally, while traditional host server frameworks distinct host servers for different cloud providers or type of cloud systems, the serverless framework and embodiments described herein are cloud agnostic and do not require distinct servers, further improving resource utilization. As an example, the cloud agnostic serverless framework according to embodiments of the present disclosure improves the telecommunication network computing capacity by up to 90% and reduces overhead such as memory usage and CPU usage by up to 90% when compared with traditional host server systems using microservices.

Embodiments of the present disclosure may include utilizing lightweight threads and associated tasks to deploy and/or implement telecommunication applications. Lightweight threads enable parallel processing of tasks on nodes with one or more clusters. Additionally, spawning a thread takes milliseconds whereas spawning microservices may take up to a hundred times more time.

Embodiments of the present disclosure may include utilizing clusters of computers to deploy and/or implement telecommunication applications in a serverless framework. The cloud agnostic serverless framework described herein may not require underlying physical infrastructure such as dedicated host servers. It may have very low system memory requirements and system storage requirements. While each thread may require 10 KB data storage and each container may require 10 MB data storage, the respective cluster a thread is executed on may include associated memory that may be used to store most thread-related and container-related information, reducing not only the system memory and storage requirements but also improving processing speed by reducing data transmission across the telecommunication network.

The cloud agnostic serverless framework described herein may eliminate the need for dedicated provisioning and managing servers. In some embodiments, dedicated orchestrator may be needed to manage thread execution and containers. Since dedicated host servers, provisioning servers, and managing servers may not be included in the cloud agnostic serverless framework, scaling up may be extremely easy. Adding one or more clusters of computers to the network infrastructure may not be as cost prohibitive as adding a server and may provide more flexibility to scale up based on developing requirements. Moreover, scaling on the application level may be easier in the cloud agnostic serverless framework described herein. Since the applications are deployed using threads that are executed on clusters of computers, provisioning additional resources on the cluster may be easier and may be implemented dynamically.

The cloud agnostic serverless framework described herein may significantly decrease the deployment time and increase the computing efficiency for telecommunication applications by leveraging parallel execution of the telecommunication applications in a plurality of clusters simultaneously. Further, using clusters instead of dedicated server infrastructure reduces installation and overhead costs and enables flexible and cost-effective scaling.

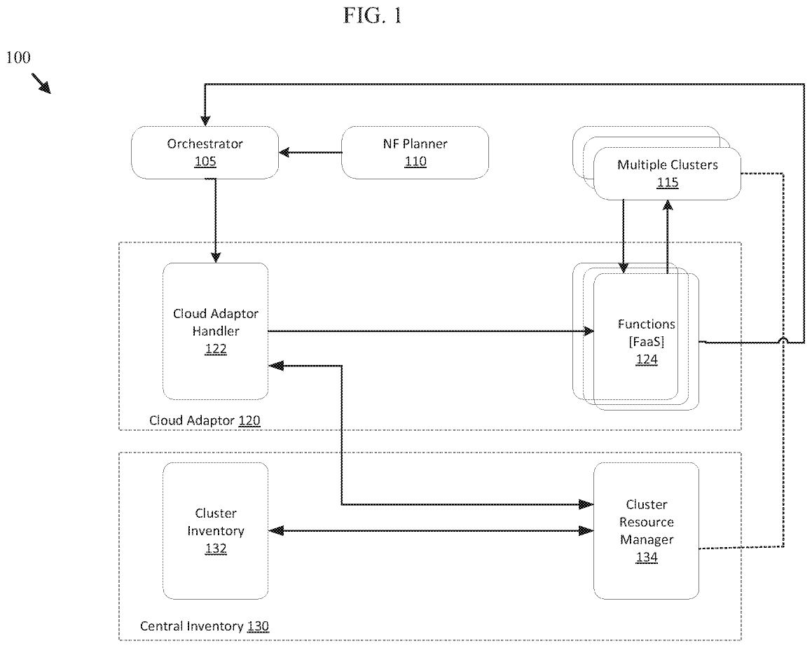

FIG. 1 is a diagram of an overview of an embodiment described herein. As shown in FIG. 1, a cloud agnostic serverless framework 100 for parallel deployment of telecommunication applications may include a cloud adaptor 120, a cloud adaptor handler 122, a plurality of functions 124, a central inventory 130, a cluster inventory 132, a cluster resource manager 134, an orchestrator 105, network function planner (NF planner) 110, and multiple clusters 115.

According to embodiments of the present disclosure, the NF planner 110 may prepare a template for network topology of the telecommunication network. The network topology of the telecommunication network may include one or more network functions or one or more network services to be deployed in parallel using the one or more available clusters from among the multiple clusters 115 and the one or more available nodes in the each of the one or more available clusters. According to embodiments of the present disclosure, the NF planner may provide the network topology to the orchestrator 105.

According to embodiments of the present disclosure, the orchestrator 105 may be an electronic device, a processor, or a computer that may manage connections and/or operations of workloads on cloud networks. The orchestrator 105 may be responsible for ensuring that processes have the proper permission to connect to a cluster computer or execute a process on the cluster computer. In some embodiments, the orchestrator 105 may receive the network topology from the NF planner 110 and transmit the network topology to the cloud adaptor 120. In some embodiments, the orchestrator 105 may transmit the network topology or template of telecommunication network to the cloud adaptor 120.

According to embodiments of the present disclosure, the cloud agnostic serverless framework 100 may include a cloud adaptor 120. The cloud adaptor 120, according to embodiments herein, may be designed to be serverless and connect with multiple cloud providers (public, private, and hybrid) and deploy telecommunication applications to update, upgrade, implement, heal, 4G & 5G telecommunication applications, Network functions (NF), Network services (NS) in any cloud platforms (including but not limited to Kubernetes, Tanzu, OpenShift, GKE, EKSCTL). The cloud adaptor 120 may deploy telecommunication applications using multiple threads. Each of the multiple threads may include one or more tasks to be executed. Using the orchestrator 105, the cloud adaptor 120 may execute the tasks associated with each thread on a respective cluster from among the one or more available clusters from multiple clusters 115. The tasks may include actions associated with at least one of deployment, deletion, restart, upgrade, healing, termination, and updating of one or more network functions or one or more network services to be deployed.

A cloud agnostic serverless framework to deploy telecommunication applications may reduce the deployment time by up to 90% and reduce infrastructure costs by up to 90% because no dedicated software, hardware, or storage may be required. Additionally, in a cloud agnostic serverless framework, no dedicated management server or orchestration server may be required.

In some embodiments, the cloud adaptor 120 may include a cloud adaptor handler 122 and a plurality of functions 124 that are available from functions as a service. The cloud adaptor handler 122 may be a multi-task scheduler, which may be configured to schedule tasks and maintain the state and life cycle of each task. In some embodiments, the cloud adaptor handler 122 may be configured to schedule threads and maintain the state and life cycle of each thread. The cloud adaptor handler 122 may maintain task resource pools and direct the parallel execution of tasks. The tasks may be executed in parallel on multiple clusters on multiple cloud providers and/or cloud platforms simultaneously. The plurality of functions 124 may be a task executors that may process the tasks spawned by the cloud adaptor handler 122.

In some embodiments, the cloud agnostic serverless framework 100 may include a central inventory 130. The central inventory 130, according to embodiments herein, may be designed to include information relating to the clusters and its resources in the multiple clusters 115. The information relating to the clusters may include cluster resource information and cluster contexts. Cluster contexts may include a group of access parameters as needed based on the cloud provider and cloud platform.

In some embodiments, the central inventory 130 may include a cluster inventory 132 and a cluster resource manager 134. The cluster resource manager 134 may dynamically allocate resources based on the type of the network function or network service associated with the one or more available clusters. The cluster resource manager 134 may apply one or more affinity rules and one or more anti-affinity rules associated with the one or more available clusters. The cluster inventory 132 may store all the information relating to the clusters in the multiple clusters 115. As an example, the cluster inventory 132 may include information relating to the resource status of the each of the one or more available clusters. The cluster inventory 132 may include cluster context associated with the each of the one or more available clusters.

The cloud agnostic serverless framework 100 may include multiple clusters 115. Each cluster may include one or more nodes and/or computers. The clusters included in the multiple clusters 115 may include a combination of multiple cloud providers or may include a combination of multiple cloud platforms. As an example, the cloud providers may include a combination of public cloud, private cloud, or hybrid cloud, and he cloud platforms may include, but not be limited to, Kubernetes®, Tanzu®, OpenShift®, GKE®, or EKSCTL®.

According to embodiments, the orchestrator 105 may receive the network topology of the telecommunication network from the NF planner 110. The orchestrator may transmit the received network topology to the cloud adaptor 120 or the cloud adaptor handler 122. The cloud adaptor 120 or the cloud adaptor handler 122 may receive the network topology of the telecommunication network.

According to embodiments of the present disclosure, the central inventory 130 may identify one or more available clusters in the multiple clusters 115 based on the network topology. In some embodiments, the cluster resource manager 134 may read the network topology received from the cloud adaptor 120 or cloud adaptor handler 122 and identify one or more available clusters and one or more nodes in each available cluster. Based on the identification, the cluster resource manager 134 may request cluster contexts for each available cluster. The cluster resource manager may receive or determine the readiness status or resource status of each of the available clusters.

The cloud adaptor 120 or cloud adaptor handler 122 may receive the resource status of each of the one or more available clusters and the cluster context associated with the each of the one or more available clusters that was identified based on the network topology. The cloud adaptor 120 or the cloud adaptor handler 122 may spawn or create a plurality of threads, with each of the plurality of threads including a task to be executed at a cluster and with each of the plurality of threads being associated with a particular cluster from the available clusters such that each task included in a thread is executed at the particular cluster associated with the thread. As an example, if there are n available clusters, n threads may be spawned or created. The threads may be light-weight, and the tasks included in the light-weight threads may be one or more functions from the multiple functions 124. The cloud adaptor 120 or the cloud adaptor handler 122 may set the cluster context associated with the particular cluster from the one or more available clusters to the function from among the functions 124 to be performed. The cloud adaptor 120 or the cloud adaptor handler 122 may direct the execution of the plurality of light-weight threads spawned or created.

According to embodiments of the present disclosure, the cloud adaptor 120 may direct the execution of the threads at their respective clusters. In some embodiments, the cloud adaptor 120 or the cloud adaptor handler 122 may receive a plurality of job identifiers from each of the available clusters, wherein the job identifiers may be a unique identifier for the task executed on the respective cluster. The cloud adaptor 120 or the cloud adaptor handler 122 may transmit the plurality of received job identifiers to the orchestrator 105. The orchestrator 105, based on the received job identifiers, may, via the cloud adaptor 120 or the cloud adaptor handler 122, poll the received plurality of job identifiers to check a status of the each job identifier; and may update the status of each job identifier based on the polling. The threads of the executed tasks may expire at the cloud adaptor 120, the cloud adaptor handler 122 or at the orchestrator 105.

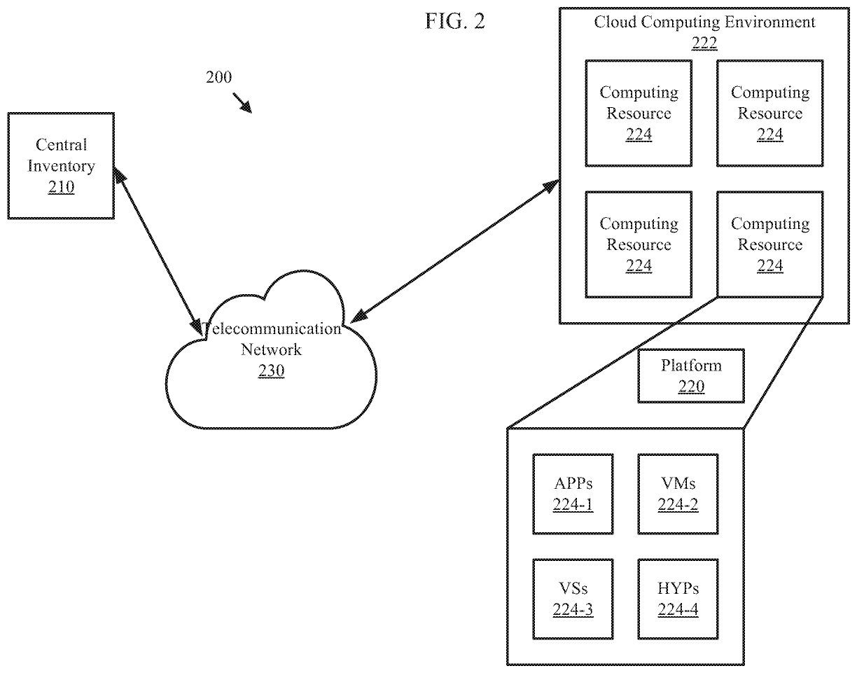

FIG. 2 is a diagram of an example environment 200 in which systems and/or methods, described herein, may be implemented. As shown in FIG. 2, environment 200 may include a central inventory 210, a platform 220, and a network 230. Devices of environment 200 may interconnect via wired connections, wireless connections, or a combination of wired and wireless connections. In embodiments, any of the functions of the elements included in cloud agnostic serverless framework 100 for parallel deployment of telecommunication applications may be performed by any combination of elements illustrated in FIG. 2.

Central inventory 210 includes one or more devices capable of receiving, generating, storing, processing, and/or providing information associated with platform 220. For example, central inventory 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, central inventory 210 may receive information from and/or transmit information to platform 220.

Platform 220 includes one or more devices capable of deploying telecommunication applications, as described elsewhere herein. In some implementations, platform 220 may include a cloud provider or a group of cloud providers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 is not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., central inventory 210) knowledge of a physical location and configuration of system(s) and/or device(s) that hosts platform 220. As shown, cloud computing environment 222 may include a group of computing resources 224 (referred to collectively as “clusters” or “computing resources 224” and individually as “computing resource 224”).

Computing resource 224 includes one or more personal computers, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like. Application 224-1 includes one or more software applications that may be provided to or accessed by central inventory 210. Application 224-1 may eliminate a need to install and execute the software applications on central inventory 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Telecommunication network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

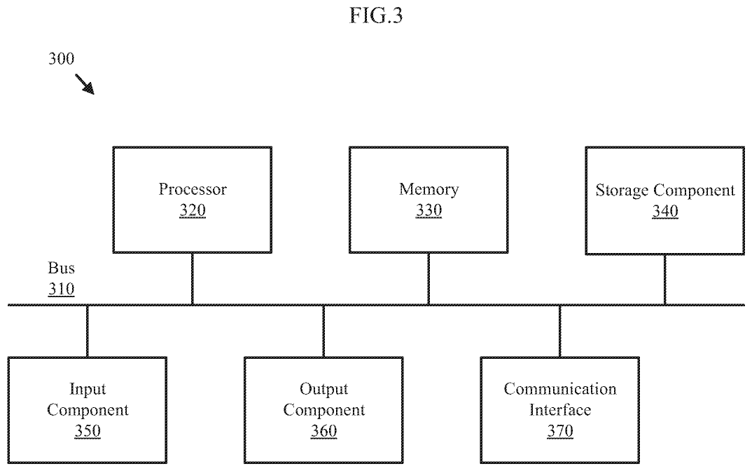

FIG. 3 is a diagram of example components of a device 300. Device 300 may correspond to central inventory 210, cloud adaptor 120, a cloud adaptor handler 122, a plurality of functions 124, a cluster inventory 132, a cluster resource manager 134, an orchestrator 105, NF planner 110, and clusters, and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable storage medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In embodiments, any one of the modules or components of FIG. 1 may be implemented by or using any one of the elements illustrated in FIGS. 2-3.

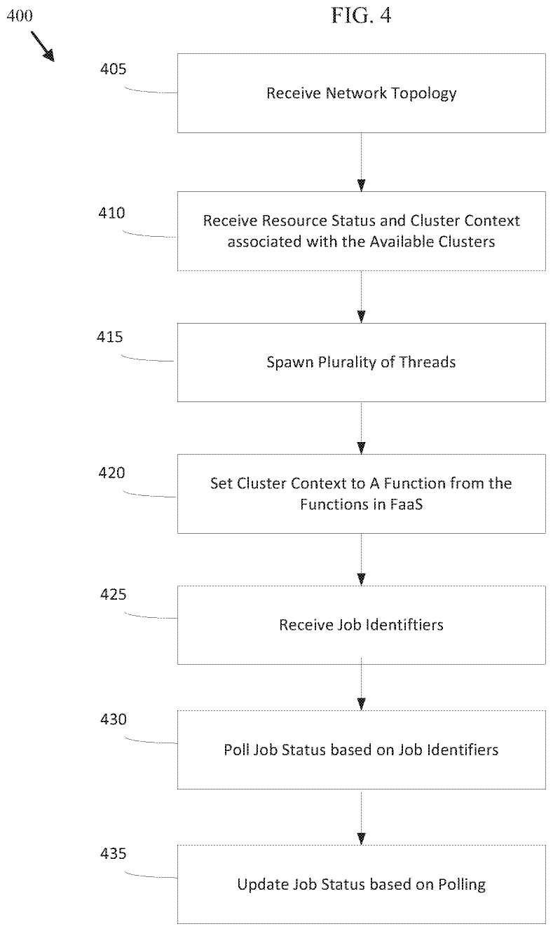

FIG. 4 is a flowchart illustrating a process 400 for parallel deployment of telecommunication applications in a cloud agnostic serverless framework. As illustrated in FIG. 4, one or more process blocks of processes 400 may be performed by any of the components of FIGS. 1-3 discussed above. As illustrated in FIG. 4, one or more process blocks of processes 400 may correspond to the cloud agnostic serverless framework 100.

As shown in FIG. 4, the process 400 may include receiving a network topology of a telecommunication network at operation 405.

At operation 410, the process 400 may include receiving resource status of each of one or more available clusters and cluster context associated with the each of the one or more available clusters, wherein the each of the one or more available clusters is identified based on the network topology. As an example, the orchestrator 105 may transmit the network topology to the central inventory 130 via the cloud adaptor 120 or the cloud adaptor handler 122. The cluster resource manager 134 which may be included in the central inventory 130 may read the network topology and identify the number of available clusters and nodes in each available cluster. The cluster resource manager 134 may also request and receive cluster contexts for the available clusters from the cluster inventory 132. The cloud adaptor 120 and cloud adaptor handler 122 may then receive the resource status of each of one or more available clusters and the cluster context associated with the each of the one or more available clusters from the cluster resource manager 134.

At operation 415, the process 400 may include spawning a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed. As an example, the cloud adaptor 120 or the cloud adaptor handler 122 may generate n threads, each thread associated with a cluster and each thread including at least one task to the executed at the cluster associated with the thread. Each task may also be associated to a function from functions 124 such that the spawned or created threads may include a task to be executed at a cluster, each of thread may be associated with a particular cluster from the available clusters, and each task included in each thread may be executed at the particular cluster associated with the thread.

At operation 420, the process 400 may include setting the cluster context associated with the respective cluster to the respective function to be performed associated with the respective task to be executed on the respective cluster. As an example, cloud adaptor 120 or the cloud adaptor handler 122 may set the cluster context associated with the particular cluster from the one or more available clusters to the function from among the functions 124 to be performed.

In some embodiments, the functions 124 which may be included in the cloud adaptor 120 may direct the respective functions from among the functions 124 being performed to connect with their respective clusters using the cluster context of the respective cluster. Once the respective functions from functions 124 may be connected to their respective clusters, the cloud adaptor 120 may begin directing the parallel execution of the telecommunication applications.

At operation 425, the process 400 may include receiving a plurality of job identifiers, from the respective clusters, wherein each job identifier is a unique identifier for the respective task to be executed on the respective cluster. As an example, the cloud adaptor 120 or the cloud adaptor handler 122 may receive a plurality of job identifiers from each of the available clusters, wherein the job identifiers may be a unique identifier for the task executed on the respective cluster.

At operation 430, the process 400 may include polling the received plurality of job identifiers to check a status of the each job identifier. As an example, cloud adaptor 120 or the cloud adaptor handler 122 may transmit the plurality of received job identifiers to the orchestrator 105. The orchestrator 105, based on the received job identifiers, may, via the cloud adaptor 120 or the cloud adaptor handler 122, poll the received plurality of job identifiers to check a status of the each job identifier. At operation 435, the process 400 may include updating the status of the each job identifier based on the polling. The threads of the executed tasks may expire at the cloud adaptor 120, the cloud adaptor handler 122 or at the orchestrator 105.

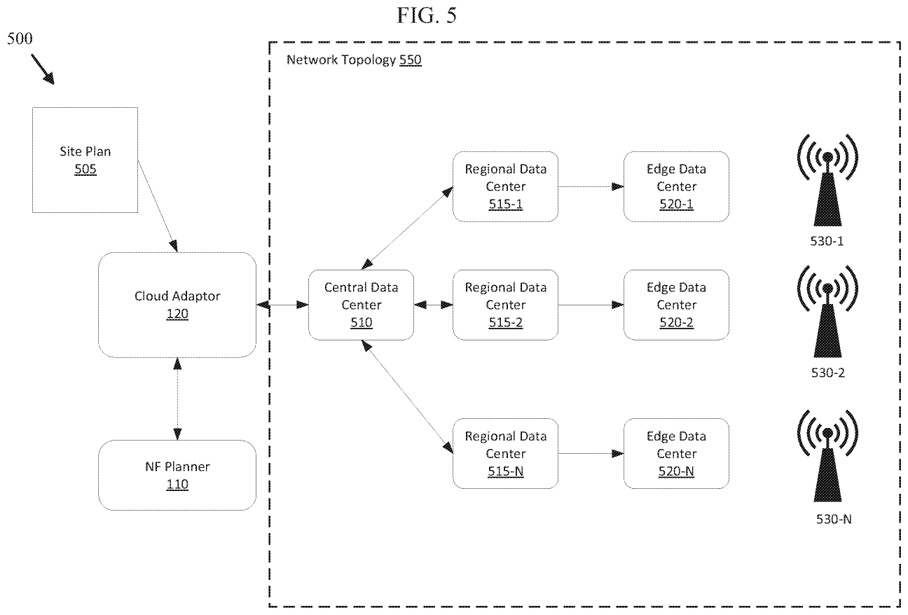

FIG. 5 is an exemplary diagram for parallel deployment of telecommunication applications in a cloud agnostic serverless framework. As shown in FIG. 5, the cloud agnostic serverless framework 500 may include a network topology 550 of a telecommunication network, a cloud adaptor 120, a NF planner 110, and a site plan 505.

According to embodiments of the present disclosure, the network topology 550 may include a central data center 510, one or more regional data centers 515 (for example, 515-1, 515-2, . . . , 515-N), one or more edge data centers 520 (for example, 520-1, 520-2, . . . , 520-N), and one or more base stations 530 or radio stations. A data center may require high connectivity that may be primarily responsible for driving content delivery, providing network functions, providing network services, mobile services, and cloud services. As an example, a central data center 510 may be the central data center driving telecommunication network services in a large geographical region such as a city, district, county, or state. A regional data center 515 may drive telecommunication network services on a regional level. A central data center 510 may include a plurality of regional data centers 520-1, 520-2 . . . 520-N. An edge data center 515 may drive telecommunication network services on a locality level. A regional data center 520 may include a plurality of edge data centers 520-1, 520-2 . . . 520-N. In some embodiments, each edge data center may provision telecommunication services via a plurality of base stations 530, cells, or radio stations.

As show in FIG. 5, the cloud agnostic serverless framework 500 may include a cloud adaptor 120, a NF planner 110, and a site plan 505. According to embodiments of the present disclosure, the NF planner 110 may prepare a template for network topology of the telecommunication network. The network topology of the telecommunication network may include one or more network functions or one or more network services to be deployed in parallel using the one or more available clusters from among the multiple clusters 115 and the one or more available nodes in the each of the one or more available clusters. According to embodiments of the present disclosure, the NF planner 110 may provide the network topology to the cloud adaptor 120 or the cloud adaptor handler 122. In some embodiments, the NF planner 110 may provide the network topology to the cloud adaptor 120 or the cloud adaptor handler 122 via the orchestrator 105.

The cloud adaptor 120 may be serverless and connect with multiple cloud providers (public, private, and hybrid) and deploy telecommunication applications to update, upgrade, implement, heal, 4G & 5G telecommunication applications, Network functions (NF), Network services (NS) in any cloud platforms (including but not limited to Kubernetes, Tanzu, OpenShift, GKE, EKSCTL). The cloud adaptor 120 may deploy telecommunication applications using multiple threads which may include one or more tasks to be executed. The site plan 505 may include a diagrammatic representation of the components of the telecommunication network and their relationships.

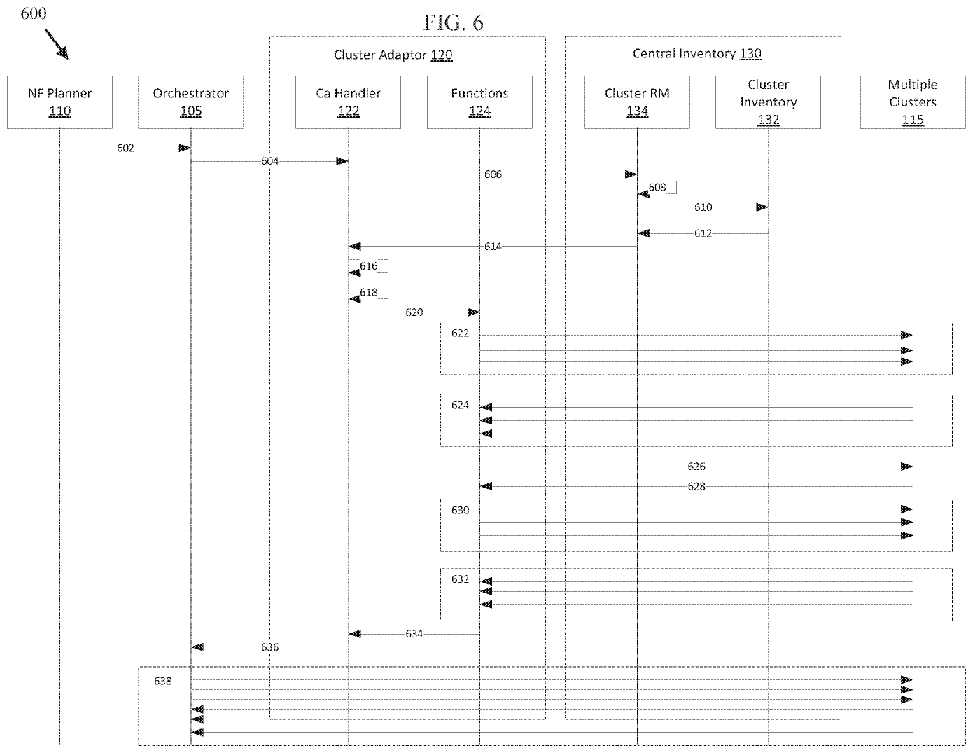

FIG. 6 illustrates a workflow for parallel deployment of telecommunication applications in a cloud agnostic serverless framework. As shown in FIG. 6, the workflow 600 may include operations between NF planner 110, orchestrator 105, cloud adaptor handler 122, functions 124, cluster resource manager 134, cluster inventory 132, and multiple clusters 115.

According to embodiments of the present disclosure, at operation 602 of the workflow 600, the NF planner 110 may transmit the network topology to the orchestrator 105. At operation 604, the cloud adaptor handler 122 may receive the network topology of a telecommunication network. The network topology may include a template of a telecommunication network. In some embodiments, the network topology may include one or more network functions or one or more network services to be deployed in parallel using the one or more available clusters and one or more available nodes in the each of the one or more available clusters.

At operation 606, the cloud adaptor handler 122 may request cluster resource status and cluster contexts of each of one or more available clusters from the cluster resource manager 134. At operation 608, the cluster resource manager 134 may read the network topology template, provided by the orchestrator 105 via the cloud adaptor handler 122, to identify the one or more available clusters and one or more nodes available in each of the one or more available clusters. At operation 610, the cluster resource manager 134 may request cluster contexts associated with each of the one or more available clusters from the cluster inventory 132. The cluster resource manager 134 and cluster inventory 132 may be included in the central inventory 130. At operation 612, the cluster inventory 132 provides the cluster contexts of each of the one or more available clusters to the cluster resource manager 134.

At operation 614, the cloud adaptor handler 122 may receive resource status of each of one or more available clusters and cluster context associated with the each of the one or more available clusters. At operation 616, the cloud adaptor handler 122 may read the number of cluster contexts received and may create a plurality of threads based on the number of cluster contexts received. At operation 618, the cloud adaptor handler 122 may spawn or create a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed. At operation 620, the cloud adaptor handler 122 may set the cluster context associated with the respective cluster to the respective function to be performed associated with the respective task to be executed on the respective cluster.

At operations 622-628, the cloud adaptor 120 (via respective functions from functions 124) may check or establish the readiness of the one or more available clusters from among the multiple clusters 115. At operation 622, the respective functions from among functions 124 that are to be performed may request connection in parallel from their respective clusters. At operation 624, the respective functions may receive an acknowledgement from the respective clusters that a connection has been established. At operation 626-628, the readiness of the one or more available clusters may be requested from the respective cluster.

At operations 630-638, the cloud adaptor 120 may direct the parallel execution of the plurality of threads across the one or more available clusters. At operation 630, the respective functions may be executed at respective clusters. Then, at operation 632, the cloud adaptor 120 may receive a plurality of job identifiers, from the respective clusters, wherein each job identifier is a unique identifier for the respective task to be executed on the respective cluster. At operation 634-636, the cloud adaptor 120 may transmit, via the cloud adaptor handler 122, the received plurality of job identifiers to the orchestrator 105. At operation 638, the orchestrator 105 may, via the cloud adaptor 120 or cloud adaptor handler 122, poll the received plurality of job identifiers to check a status of the each job identifier. Then the status of each job identifier of the plurality of job identifiers may be updated by the orchestrator 105 via the cloud adaptor 120 or the cloud adaptor handler 122.

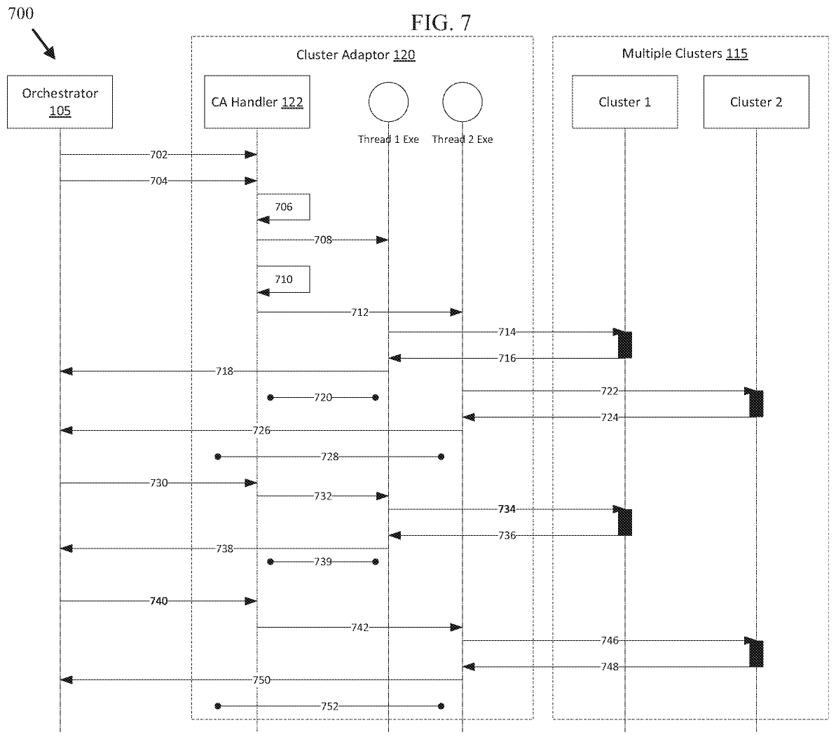

FIG. 7 illustrates a workflow for parallel deployment of telecommunication applications in a cloud agnostic serverless framework. As shown in FIG. 7, the workflow 700 may include operations between orchestrator 105, cloud adaptor handler 122, plurality of threads including thread 1 and thread 2, and multiple clusters 115 including cluster 1 and cluster 2.

According to embodiments of the present disclosure, at operations 702-704 of the workflow 700, the cloud adaptor handler 122 may receive multiple requests to deploy telecommunication applications. Based on the received request, at operations 706 and 710 the cloud adaptor handler 122 may be spawn thread 1 and thread 2. Then, the cluster context and respective function and/or tasks to be performed may be set and sent to the executor associated with thread 1 and thread 2 at operations 708 and 712 respectively.

At operations 714-728, the telecommunication applications may be deployed on their respective clusters. At operations 714 and 722, the respective functions and/or tasks (deploy, delete, restart, update, upload, etc.) may be executed at cluster 1 and cluster 2 respectively. At operations 716 and 724, cloud adaptor handler 122 may receive the respective job identifiers for the respective functions and/or tasks being executed at cluster 1 and cluster 2 respectively. At operations 718 and 726, the orchestrator may receive the respective job identifiers for the respective functions and/or tasks being executed at cluster 1 and cluster 2 respectively. At operations 710 and 728, thread 1 and thread 2 may expire after their functions and/or tasks are performed.

At operations 730 and 740, the cloud adaptor handler 122 may be receive polling requests from the orchestrator 105 to poll the received job identifiers to check a status of the each job identifier. At operations 732 and 742, the cloud adaptor handler 122 may spawn or create new threads to determine the status of the each job identifier respectively. At operations 734-736 and 744-746, the cloud adaptor 120 may poll the received plurality of job identifiers to check the status of the each job identifier. At operations 738 and 750, the cloud adaptor 120 may update the status of the each job identifier based on the polling. At operations 739 and 752, the threads spawned or created to poll the received job identifiers may expire after determining the status of each job identifier.

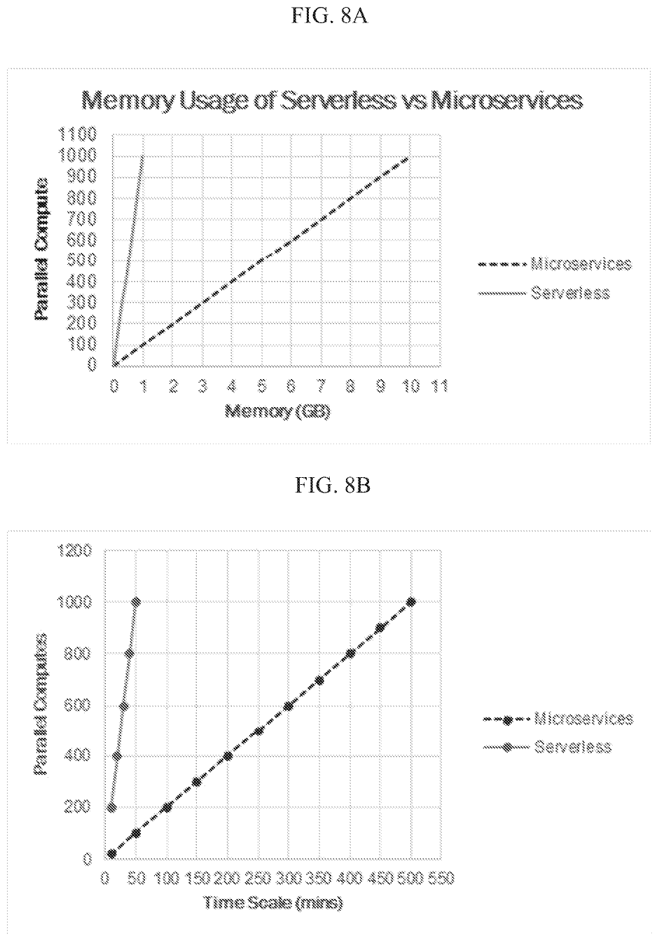

As shown in FIG. 8A, deploying telecommunication applications in a cloud agnostic serverless framework according to embodiments of the present disclosure may increase storage efficiency and reduce storage requirements by up to 90% when compared to previous methods utilizing server-based system that uses microservices.

As shown in FIG. 8B, deploying telecommunication applications in a cloud agnostic serverless framework according to embodiments of the present disclosure may increase the computation efficiency by up to 90% when compared to previous methods utilizing server-based system that uses microservices.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for parallel deployment of telecommunication applications, executed by a cloud adaptor including one or more processors, the method comprising:
receiving a network topology of a telecommunication network;
receiving a resource status of each of one or more available clusters and a cluster context associated with the each of the one or more available clusters, wherein the each of the one or more available clusters is identified based on the network topology;
spawning a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed;
setting the cluster context associated with the respective cluster to the respective function to be performed associated with the respective task to be executed on the respective cluster; and
directing parallel execution of the plurality of threads across the one or more available clusters.

2. The method of claim 1, wherein the directing the parallel execution of the plurality of threads comprises:
receiving a plurality of job identifiers, wherein each job identifier of the plurality of job identifiers is a unique identifier for the respective task to be executed on the respective cluster;
polling the each job identifier of the plurality of job identifiers to check a status of the each job identifier; and
updating the status of the each job identifier based on the polling.

3. The method of claim 1, wherein the network topology includes a template of a telecommunication network.

4. The method of claim 1, wherein the network topology includes one or more network functions or one or more network services to be deployed in parallel using the one or more available clusters and one or more available nodes in the each of the one or more available clusters.

5. The method of claim 1, wherein the resource status of the each of the one or more available clusters and the cluster context of the each of the one or more available clusters are received from a central inventory.

6. The method of claim 1, wherein the task includes actions associated with at least one of deployment, deletion, restart, upgrade, healing, termination, and updating of one or more network functions or one or more network services to be deployed.

7. The method of claim 1, wherein the one or more available clusters include at least one of a public cluster, a private cluster, a hybrid cluster, or a combination thereof.

8. The method of claim 1, wherein the resource status of the each of the one or more available clusters is based on a network function or a network service associated with the one or more available clusters, one or more affinity rules associated with the one or more available clusters, and one or more anti-affinity rules associated with the one or more available clusters.

9. The method of claim 2, wherein the plurality of job identifiers are received from the each of the respective cluster where the respective task is to be executed.

10. An apparatus comprising:
a memory configured to store instructions; and
one or more processors configured to execute the instructions to:
receive a network topology of a telecommunication network;
receive a resource status of each of one or more available clusters and a cluster context associated with the each of the one or more available clusters, wherein the each of the one or more available clusters is identified based on the network topology;
spawn a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed;
set the cluster context associated with the respective cluster to the respective function to be performed associated with the respective task to be executed on the respective cluster; and
direct parallel execution of the plurality of threads across the one or more available clusters.

11. The apparatus of claim 10, wherein the directing comprises:
receiving a plurality of job identifiers, wherein each job identifier of the plurality of job identifiers is a unique identifier for the respective task to be executed on the respective cluster;
polling the each job identifier of the plurality of job identifiers to check a status of the each job identifier; and
updating the status of the each job identifier based on the polling.

12. The apparatus of claim 10, wherein the network topology includes a template of a telecommunication network.

13. The apparatus of claim 10, wherein the network topology includes one or more network functions or one or more network services to be deployed in parallel using the one or more available clusters and one or more available nodes in the each of the one or more available clusters.

14. The apparatus of claim 10, wherein the resource status of the each of the one or more available clusters and the cluster context of the each of the one or more available clusters are received from a central inventory.

15. The apparatus of claim 10, wherein the task includes actions associated with at least one of deployment, deletion, restart, upgrade, healing, termination, and updating of one or more network functions or one or more network services to be deployed.

16. The apparatus of claim 10, wherein the one or more available clusters include at least one of a public cluster, a private cluster, a hybrid cluster, or a combination thereof.

17. The apparatus of claim 10, wherein the resource status of the each of the one or more available clusters is based on a network function or a network service associated with the one or more available clusters, one or more affinity rules associated with the one or more available clusters, or one or more anti-affinity rules associated with the one or more available clusters.

18. A non-transitory computer-readable medium storing instructions, the instructions comprising: one or more instructions that, when executed by a cloud adaptor comprising one or more processors, cause the one or more processors to:
receive a network topology of a telecommunication network;
receive a resource status of each of one or more available clusters and a cluster context associated with the each of the one or more available clusters, wherein the each of the one or more available clusters is identified based on the network topology;
spawn a plurality of threads, wherein each of the plurality of threads is associated with a respective cluster from the one or more available clusters, wherein the each of the plurality of threads includes a respective task to be executed on the respective cluster from the one or more available clusters, and wherein the respective task is associated with a respective function from among a plurality of functions to be performed;
set the cluster context associated with the respective cluster to the respective function to be performed associated with the respective task to be executed on the respective cluster; and
direct parallel execution of the plurality of threads across the one or more available clusters.

19. The non-transitory computer-readable medium of claim 18, wherein the directing comprises:
receiving a plurality of job identifiers, wherein each job identifier of the plurality of job identifiers is a unique identifier for the respective task to be executed on the respective cluster;
polling the each job identifier of the plurality of job identifiers to check a status of the each job identifier; and
updating the status of the each job identifier based on the polling.

20. The non-transitory computer-readable medium of claim 18, wherein the resource status of the each of the one or more available clusters is based on a network function or a network service associated with the one or more available clusters, one or more affinity rules associated with the one or more available clusters, or one or more anti-affinity rules associated with the one or more available clusters.
